(19) United States
(12) Patent Application Publication
(10) Pub. No.: US 2023/0292311 A1
(43) Pub. Date: Sep. 14, 2023

(54) UPLINK TRANSMIT SWITCHING FOR TWO FREQUENCY BANDS

(71) Applicant: QUALCOMM Incorporated, San Diego, CA (US)

(72) Inventors: Yiqing CAO, Beijing (CN); Peter GAAL, San Diego, CA (US); Yan LI, Beijing (CN)

(21) Appl. No.: 18/006,137

(22) PCT Filed: Sep. 10, 2021
(86) PCT No.: PCT/CN2021/117614

§ 371 Date: Jan. 19, 2023

(30) Foreign Application Priority Data
Sep. 11, 2020 (WO) PCT/CN2020/114660

(51) Int. Cl. H04W 72/1268; H04L 5/00

(52) U.S. Cl. CPC H04W 72/1268; H04L 5/0023; H04L 5/001

(57) ABSTRACT

Various aspects of the present disclosure generally relate to wireless communication. In some aspects, a user equipment (UE) may transmit an indication of one or more switching options supported by the UE, wherein the one or more switching options are associated with performing uplink transmit switching for a first band and a second band. At least one of the first band or the second band is a frequency-division duplex band, a time-division duplex band, or a supplemental uplink band. Uplink multiple-input multiple-output is permitted on the first band and the second band. The UE may receive, after transmitting the indication of the one or more switching options, information associated with an uplink transmission scheduled for the UE, wherein the uplink transmission is scheduled according to the one or more switching options supported by the UE. Numerous other aspects are provided.

### CROSS-REFERENCE TO RELATED APPLICATION

This Patent application claims priority to Patent Cooperation Treaty (PCT) Application No. PCT/CN2020/114660, filed on Sep. 11, 2020, entitled “UPLINK TRANSMIT SWITCHING FOR TWO FREQUENCY BANDS,” and assigned to the assignee hereof. The disclosure of the prior Application is considered part of and is incorporated by reference into this Patent Application.

### FIELD OF THE DISCLOSURE

Aspects of the present disclosure generally relate to wireless communication and to techniques and apparatuses for uplink transmit switching for two frequency bands.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. NR, which may be referred to as 5G, is a set of enhancements to the LIE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes transmitting an indication of one or more switching options supported by the UE, wherein the one or more switching options are associated with performing uplink transmit switching for a first band and a second band, wherein at least one of the first band or the second band is a frequency-division duplex (FDD) band, a time-division duplex (TDD) band, or a supplemental uplink (SUL) band, and wherein uplink multiple-input multiple-output (MIMO) is permitted on the first band and the second band; and receiving, after transmitting the indication of the one or more switching options, information associated with an uplink transmission scheduled for the UE, wherein the uplink transmission is scheduled according to the one or more switching options supported by the UE.

In some aspects, a method of wireless communication performed by a base station includes receiving indication of one or more switching options supported by a UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and transmitting, after receiving the indication of the one or more switching options, information associated with an uplink transmission scheduled for the UE, wherein the uplink transmission is scheduled according to the one or more switching options supported by the UE.

In some aspects, a UE for wireless communication includes a memory; and one or more processors coupled with the memory, the one or more processors configured to: transmit an indication of one or more switching options supported by the UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and receive, after transmitting the indication of the one or more switching options, information associated with an uplink transmission scheduled for the UE, wherein the uplink transmission is scheduled according to the one or more switching options supported by the UE.

In some aspects, a base station for wireless communication includes a memory; and one or more processors coupled with the memory, the one or more processors configured to: receive an indication of one or more switching options supported by a UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and transmit, after receiving the indication of the one or more switching options, information associated with an uplink transmission scheduled for the UE, wherein the uplink transmission is scheduled according to the one or more switching options supported by the UE.

In some aspects, a non-transitory computer-readable medium storing a set of instructions for wireless communication includes one or more instructions that, when executed by one or more processors of a UE, cause the UE to: transmit an indication of one or more switching options supported by the UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and receive, after transmitting the indication of the one or more switching options, information associated with an uplink transmission scheduled for the UE, wherein the uplink transmission is scheduled according to the one or more switching options supported by the UE.

In some aspects, a non-transitory computer-readable medium storing a set of instructions for wireless communication includes one or more instructions that, when executed by one or more processors of a base station, cause the base station to: receive an indication of one or more switching options supported by a UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and transmit, after receiving the indication of the one or more switching options, information associated with an uplink transmission scheduled for the UE, wherein the uplink transmission is scheduled according to the one or more switching options supported by the UE.

In some aspects, an apparatus for wireless communication includes means for transmitting an indication of one or more switching options supported by the apparatus, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and means for receiving, after transmitting the indication of the one or more switching options, information associated with an uplink transmission scheduled for the apparatus, wherein the uplink transmission is scheduled according to the one or more switching options supported by the apparatus.

In some aspects, an apparatus for wireless communication includes means for receiving an indication of one or more switching options supported by a UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; and means for transmitting, after receiving the indication of the one or more switching options, information associated with an uplink transmission scheduled for the UE, wherein the uplink transmission is scheduled according to the one or more switching options supported by the UE.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 is a diagram illustrating examples of carrier aggregation, in accordance with the present disclosure.

FIG. 4 is a diagram illustrating an example associated with uplink transmit switching for two frequency bands, in accordance with the present disclosure.

FIGS. 5 and 6 are diagram illustrating example processes associated with uplink transmit switching for two frequency bands, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

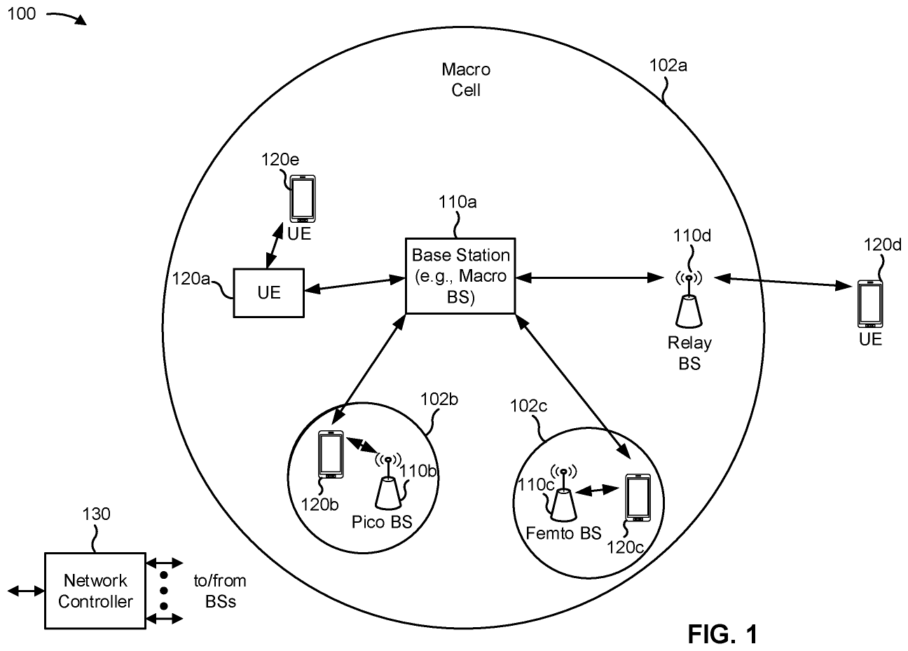

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As indicated above, FIG. 1 is provided as an example. Other examples may differ from what is described with regard to FIG. 1.

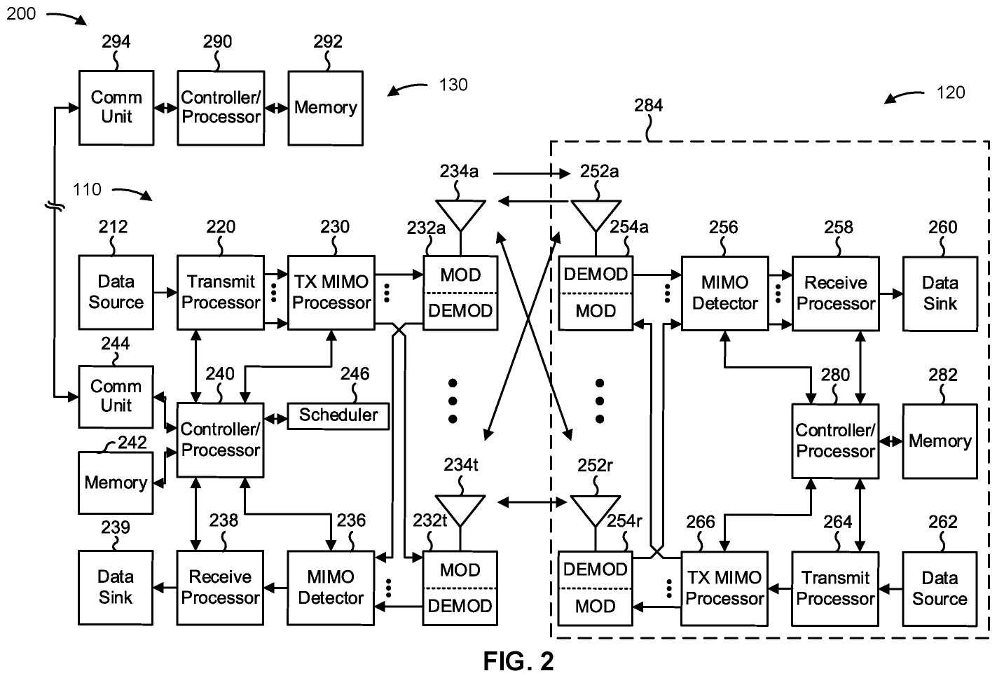

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The UE 120 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

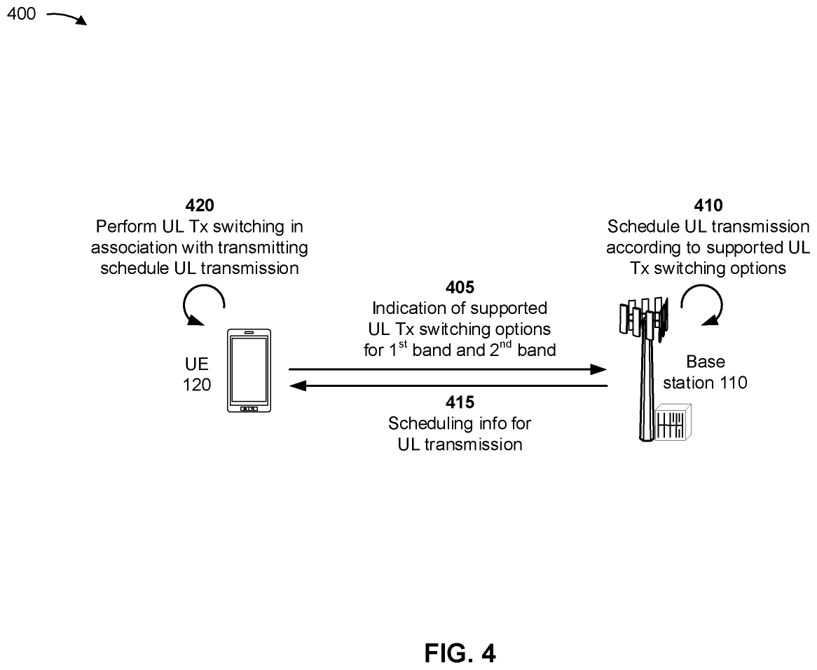

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4-6.

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4-6.

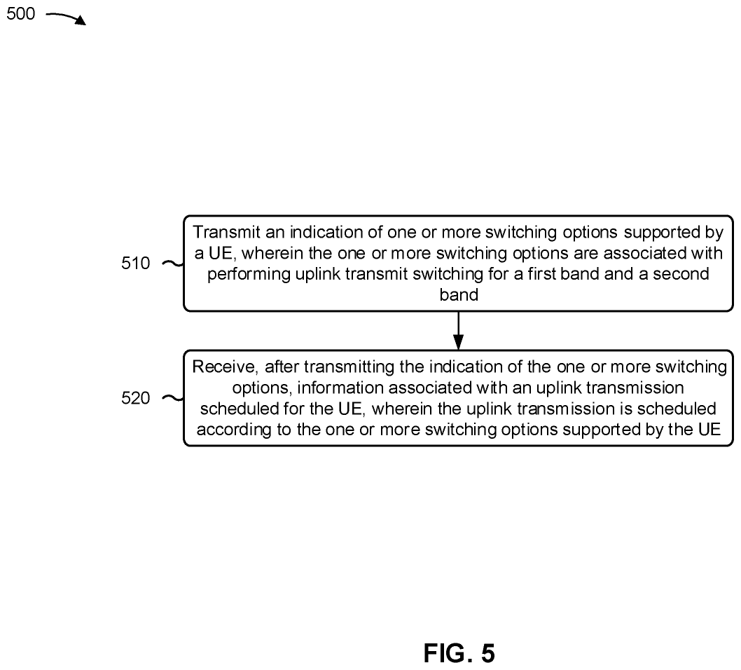

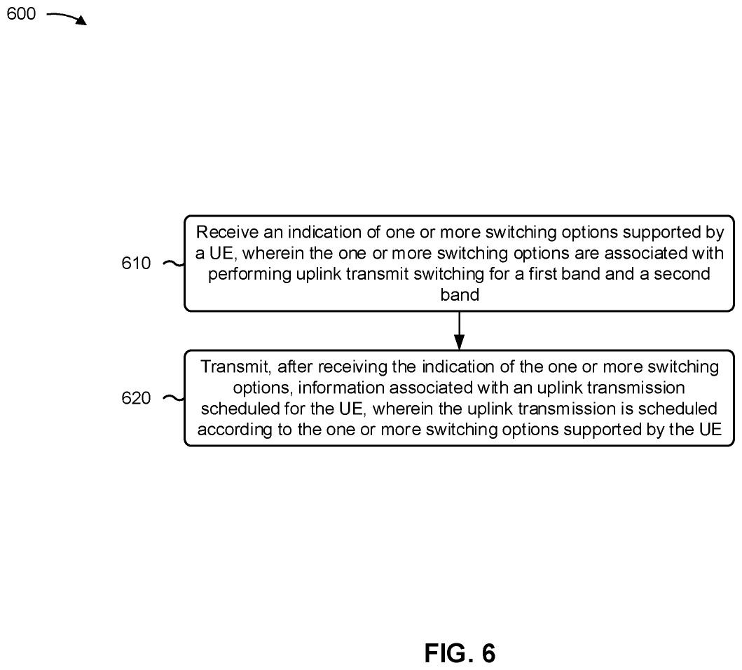

The controller/processor 240 of the base station 110, the controller/processor 280 of the UE 120, and/or any other component(s) of FIG. 2 may perform one or more techniques associated with uplink transmit switching for two frequency bands, as described in more detail elsewhere herein For example, the controller/processor 240 of the base station 110, the controller/processor 280 of the UE 120, and/or any other component(s) of FIG. 2 may perform or direct operations of, for example, process 500 of FIG. 5, process 600 of FIG. 6, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, 500 of FIG. 5, process 600 of FIG. 6, and/or other processes as described herein. In some examples, executing instructions may include running the instructions, converting the instructions, compiling the instructions, and/or interpreting the instructions, among other examples.

In some aspects, UE 120 may include means for transmitting an indication of one or more switching options supported by the UE, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; means for receiving, after transmitting the indication of the one or more switching options, information associated with an uplink transmission scheduled for the UE, wherein the uplink transmission is scheduled according to the one or more switching options supported by the UE; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting an indication of one or more switching options supported by a UE 120, wherein the one or more switching options are associated with performing uplink transmit switching for a first band and a second band, wherein at least one of the first band or the second band is an FDD band, a TDD band, or an SUL band, and wherein uplink MIMO is permitted on the first band and the second band; means for transmitting, after receiving the indication of the one or more switching options, information associated with an uplink transmission scheduled for the UE, wherein the uplink transmission is scheduled according to the one or more switching options supported by the UE; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

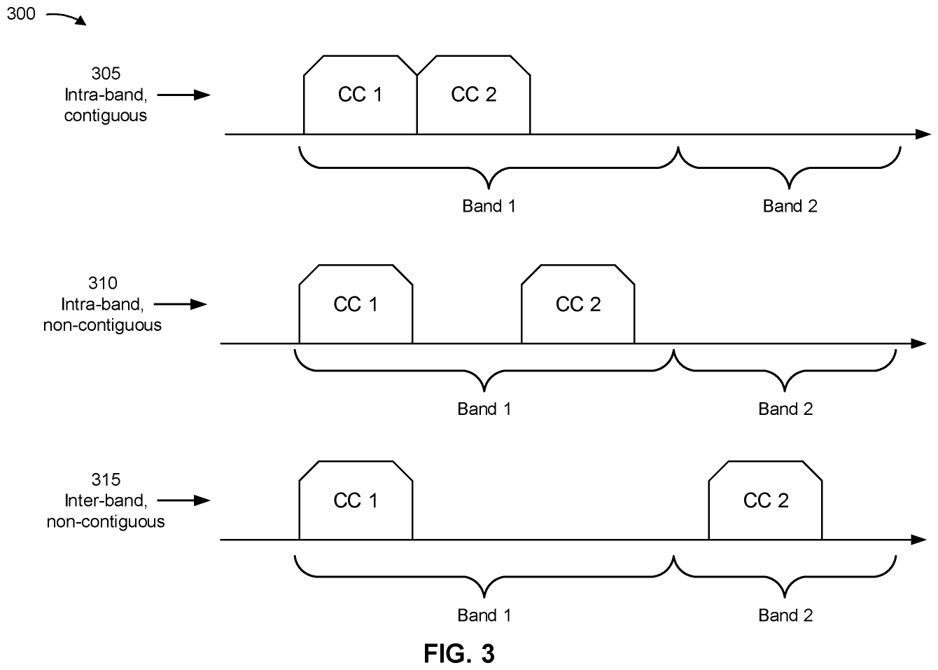

FIG. 3 is a diagram illustrating examples 300 of carrier aggregation, in accordance with the present disclosure.

Carrier aggregation is a technology that enables two or more component carriers (CCs, sometimes referred to as carriers) to be combined (e.g., into a single channel) for a single UE 120 to enhance data capacity. As shown, carriers can be combined in the same or different frequency bands. Additionally, or alternatively, contiguous or non-contiguous carriers can be combined. A base station 110 may configure carrier aggregation for a UE 120, such as in a radio resource control (RRC) message, downlink control information (DCI), and/or the like.

As shown by reference number 305, in some aspects, carrier aggregation may be configured in an intra-band contiguous mode where the aggregated carriers are contiguous to one another and are in the same band. As shown by reference number 310, in some aspects, carrier aggregation may be configured in an intra-band non-contiguous mode where the aggregated carriers are non-contiguous to one another and are in the same band. As shown by reference number 315, in some aspects, carrier aggregation may be configured in an inter-band non-contiguous mode where the aggregated carriers are non-contiguous to one another and are in different bands.

In carrier aggregation, a UE 120 may be configured with a primary carrier and one or more secondary carriers. In some aspects, the primary carrier may carry control information (e.g., downlink control information, scheduling information, and/or the like) for scheduling data communications on one or more secondary carriers, which may be referred to as cross-carrier scheduling. In some aspects, a carrier (e.g., a primary carrier or a secondary carrier) may carry control information for scheduling data communications on the carrier, which may be referred to as self-carrier scheduling or carrier self-scheduling.

As indicated above, FIG. 3 is provided as an example. Other examples may differ from what is described with regard to FIG. 3.

In some wireless communication systems, a UE may be capable of using two frequency bands to support uplink inter-band carrier aggregation (CA). Commonly, in association with supporting uplink inter-band CA, a first transmit chain of the UE is used for communicating on a time-division duplex (TDD) band and a second transmit chain of the UE is used for communicating on a frequency-division duplex (FDD) band. In some wireless communication systems, it is desirable to support uplink MIMO for the TDD band. In such case, because the UE includes only two transmit chains, the UE needs to perform uplink transmit switching that causes one of the two transmit chains to switch back-and-forth between the TDD band and the FDD band. However, in some cases, the UE may be configured to communicate using two TDD bands. To better utilize available TDD bands, it is desirable to extend uplink transmit switching to cover uplink transmit switching for two TDD bands (rather than a TDD band and an FDD band).

Further, supplemental uplink (SUL) is supported in some wireless communication systems. Notably, SUL may have different (e.g., standards imposed) limitations than CA. Therefore, options for performing uplink transmit switching for SUL may differ from those for performing uplink transmit switching for CA. For example, uplink MIMO may not be permitted for a frequency band used for SUL, meaning that only port can be scheduled for SUL. As another example, concurrent transmission on two bands may not be supported when one of the bands is an SUL band. Thus, an issue to be addressed in association with providing uplink transmit switching for two TDD bands is that CA and SUL have different switching options (due to the limitations of SUL). Therefore, knowledge of switching options of which a UE is capable is needed in association with scheduling an uplink transmission in an uplink transmit switching scenario.

Additionally, asynchronous CA is supported in some wireless communication systems. In conventional (synchronous) CA, full alignment in the time domain between different bands is provided (e.g., system frame numbers (SFN) are aligned between the different bands), meaning that all transmissions on the different bands are fully synchronized. Conversely, asynchronous CA provides slot level synchronization, meaning that there could be an uplink staggered pattern between two frequency bands on the slot level. Notably, asynchronous CA and uplink transmit switching for two TDD bands may be utilized together in order to increase uplink transmission capability of the UE. However, an issue to be addressed in association with providing uplink transmit switching in an asynchronous CA scenario is that the UE needs to determine whether sufficient switching time and preparation time is provided in association with performing uplink transmit switching.

Some aspects described herein provide techniques and apparatuses for uplink transmit switching for two frequency bands. In some aspects, a UE may transmit, and a base station may receive, an indication of one or more switching options supported by the UE. Here, the one or more switching options are associated with performing uplink transmit switching for a first band and a second band. In some aspects, at least one of the first band or the second band is an FDD band, a TDD band, or an SUL band. In some aspects, the base station may transmit, and the UE may receive, information associated with an uplink transmission scheduled for the UE, where the uplink transmission is scheduled according to the one or more switching options supported by the UE. Additional details are provided below.

FIG. 4 is a diagram illustrating an example 400 associated with uplink transmit switching for two frequency bands, in accordance with the present disclosure. As shown in FIG. 4, example 400 includes communication between a base station 110 and a UE 120. In some aspects, the base station 110 and the UE 120 may be included in a wireless network, such as wireless network 100. Base station 110 and UE 120 may communicate on a wireless access link, which may include an uplink and a downlink.

As shown by reference number 405 in FIG. 4, the UE 120 may transmit, and the base station 110 may receive, an indication of one or more switching options supported by the UE 120. In some aspects, the one or more switching options are associated with performing uplink transmit switching for a first band and a second band. Thus, in some aspects, the UE 120 transmits, and the base station 110 receives, an indication of one or more switching options supported by the UE 120 for performing uplink transmit switching for the first and second bands.

In some aspects, at least one of the first band or the second band is an FDD band, a TDD band, or an SUL band. For example, in some aspects, the first band is a first FDD band and the second band is a second FDD band. As another example, in some aspects, the first band is a TDD band and the second band is an SUL band. As another example, in some aspects, the first band is a first TDD band, and the second band is a second TDD band. Thus, the one or more switching options may in some aspects be associated with performing uplink transmit switching for two TDD bands.

As shown by reference number 410, the base station 110 may schedule an uplink transmission according to the one or more switching options supported by the UE 120. For example, the base station 110 may receive the indication of the one or more switching options supported by the UE 120 in association with performing uplink transmit switching for the first band and the second band. Here, the base station 110 schedules an uplink transmission for the UE 120 based at least in part on the one or more switching options supported by the UE 120. That is, the base station 110 may schedule the uplink transmission such that any uplink transmit switching needed to be performed by the UE 120 in association with transmitting the uplink transmission is supported by (i.e., can be performed by) the UE 120.

As shown by reference number 415, the base station 110 may transmit, and the UE 120 may receive, information associated with the uplink transmission scheduled for the UE 120. That is, after transmitting the indication of the one or more switching options supported by the UE 120, the UE 120 may receive scheduling information associated with the uplink transmission scheduled by the base station 110 according to the one or more switching options supported by the UE 120.

As shown by reference number 420, after receiving the scheduling information, the UE 120 may perform uplink transmit switching in association with transmitting the uplink transmission. For example, the UE 120 may receive the scheduling information, may determine that the UE 120 is to perform uplink transmit switching in association with transmitting the uplink transmission, and may perform the uplink transmit switching accordingly. In some aspects, the UE 120 transmits the uplink transmission after performing the uplink transmit switching. In some aspects, the may transmit the uplink transmission without performing uplink transmit switching (e.g., when the uplink transmission is scheduled such that the UE 120 need not perform uplink transmit switching in order to transmit the uplink transmission).

In some aspects, the second band is an SUL band, and uplink MIMO is not permitted on the SUL band.

In one example aspect, the one or more switching options include a switching option associated with switching among a first configuration, a second configuration, and a third configuration. In the first configuration, the first antenna port is associated with the first band and the second antenna port is associated with the second band. Here, the first configuration may support scheduling of uplink transmissions on a second antenna port only, scheduling of uplink transmissions on a first antenna port only, and no uplink transmissions being scheduled on either the first antenna port or the second antenna port. In the second configuration, the first antenna port and the second antenna port are associated with the second band. Here, the second configuration may support scheduling of uplink transmissions on the second antenna port only, and no uplink transmissions being scheduled on either the first antenna port or the second antenna port. In the third configuration, the first antenna port and the second antenna port are associated with the first band. Here, the third configuration may support scheduling of concurrent uplink transmissions on the first antenna port and the second antenna port, scheduling of uplink transmissions on the first antenna port only, and no uplink transmissions being scheduled on either the first antenna port or the second antenna port.

In another example aspect, the one or more switching options include a switching option associated with switching among a first configuration, a second configuration, and a third configuration. In the first configuration, the first antenna port is associated with the first band and the second antenna port is associated with the second band. Here, the first configuration may support scheduling of concurrent uplink transmissions on a first antenna port and a second antenna port, scheduling of uplink transmissions on the second antenna port only, scheduling of uplink transmissions on the first antenna port only, and no uplink transmissions being scheduled on either the first antenna port or the second antenna port. In the second configuration, the first antenna port and the second antenna port are associated with the second band. Here, the second configuration may support scheduling of concurrent uplink transmissions on the first antenna port and the second antenna port, scheduling of uplink transmissions on the second antenna port only, and no uplink transmissions being scheduled on either the first antenna port or the second antenna port. In the third configuration, the first antenna port and the second antenna port are associated with the first band. Here, the third configuration may support scheduling of concurrent uplink transmissions on the first antenna port and the second antenna port, scheduling of uplink transmissions on the first antenna port only, and no uplink transmissions being scheduled on either the first antenna port or the second antenna port.

In some aspects, the second band is an SUL band, and uplink MIMO is permitted on the SUL band.

In one example aspect, the one or more switching options include a switching option associated with switching among a first configuration, a second configuration, and a third configuration. In the first configuration, the first antenna port is associated with the first band and the second antenna port is associated with the second band. Here, the first configuration may support scheduling of uplink transmissions on a second antenna port only, scheduling of uplink transmissions on a first antenna port only, and no uplink transmissions being scheduled on either the first antenna port or the second antenna port. In the second configuration, the first antenna port and the second antenna port are associated with the second band. Here, the second configuration may support scheduling of concurrent uplink transmissions on the first antenna port and the second antenna port, scheduling of an uplink transmission on the second antenna port only, and no uplink transmissions being scheduled on either the first antenna port or the second antenna port. In the third configuration, the first antenna port and the second antenna port are associated with the first band. Here, the third configuration may support scheduling of concurrent uplink transmissions on the first antenna port and the second antenna port, scheduling of an uplink transmission on the first antenna port only, and no uplink transmissions being scheduled on either the first antenna port or the second antenna port.

In another example aspect, the one or more switching options include a switching option associated with switching among a first configuration, a second configuration, a third configuration. In the first configuration, the first antenna port is associated with the first band and the second antenna port is associated with the second band. Here, the first configuration may support scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port. In the second configuration, the first antenna port and the second antenna port are associated with the second band. Here, the second configuration may support scheduling of concurrent uplink transmissions on the first antenna port and the second antenna port, scheduling of an uplink transmission on the second antenna port only, and no uplink transmissions being scheduled on either the first antenna port or the second antenna port. In the third configuration, the first antenna port and the second antenna port are associated with the first band. Here, the third configuration may support scheduling of concurrent uplink transmissions on the first antenna port and the second antenna port, scheduling of an uplink transmission on the first antenna port only, and no uplink transmissions being scheduled on either the first antenna port or the second antenna port.

In some aspects, the UE 120 may determine whether the uplink transmission is scheduled to provide the UE 120 with sufficient time to perform uplink transmit switching in accordance with a carrier aggregation slot offset value (e.g., CA_slot_offset). For example, the UE 120 may determine that insufficient time is provided when the UE is to transmit in the uplink based on information (e.g., one or more DCIs) received before a time T0−T_{offset}−CA_slot_offset or based on a higher layer configuration(s) before switching, where T0 is a start time of a first symbol of the transmission occasion of the uplink channel or signal, T_{offset} is a preparation procedure time of the transmission occasion of the uplink channel or signal, and CA_Slot_offset is derived by a higher layer configuration ca-SlotOffset. In some aspects, the CA_Slot_offset is an absolute time value, an example of which is as follows:

$$⌊ ( \frac{{N}_{slot , offset , PDCCH}^{CA}}{{2}^{{μ}_{offset , PDCCH}}} - \frac{{N}_{slot , offset , PDSCH}^{CA}}{{2}^{{μ}_{offset , PDSCH}}} ) \cdot {2}^{{μ}_{PDSCH}} ⌋ * Tslot , PDSCH$$

where Tslot, PDSCH is a slot time (e.g., in milliseconds) of a physical downlink shared channel.

In some aspects, the UE 120 is configured to expect that the uplink transmission is scheduled to provide the UE 120 with sufficient time to perform uplink transmit switching in accordance with a carrier aggregation slot offset value.

In some aspects, the UE 120 may identify a switching scheduling error case based at least in part on a determination that the uplink transmission is not scheduled so as to provide the UE sufficient time to perform the uplink transmit switching.

In some aspects, the UE 120 may skip the performance of the uplink transmit switching in association with transmitting the uplink transmission based at least in part on a determination that the uplink transmission is not scheduled so as to provide the UE sufficient time to perform the uplink transmit switching.

Notably, in some aspects, the UE 120 is configured for intra-band CA. In such a case, the UE 120 may be configured to check component carriers in a band used for intra-band CA in association with determining whether to perform uplink transmit switching.

As indicated above, FIG. 4 is provided as an example. Other examples may differ from what is described with respect to FIG. 4.

FIG. 5 is a diagram illustrating an example process 500 performed, for example, by a UE, in accordance with the present disclosure. Example process 500 is an example where the UE (e.g., UE 120) performs operations associated with uplink transmit switching for two frequency bands.

As shown in FIG. 5, in some aspects, process 500 may include transmitting an indication of one or more switching options supported by the UE, wherein the one or more switching options are associated with performing uplink transmit switching for a first band and a second band (block 510). For example, the UE (e.g., using antenna 252, transmit processor 264, TX MIMO processor 266, modulator 254, controller/processor 280, and/or memory 282) may transmit an indication of one or more switching options supported by the UE, wherein the one or more switching options are associated with performing uplink transmit switching for a first band and a second band, as described above. In some aspects, at least one of the first band or the second band is an FDD band, a TDD band, or an SUL band. In some aspects, uplink MIMO is permitted on the first band and the second band.

As further shown in FIG. 5, in some aspects, process 500 may include receiving, after transmitting the indication of the one or more switching options, information associated with an uplink transmission scheduled for the UE, wherein the uplink transmission is scheduled according to the one or more switching options supported by the UE (block 520). For example, the UE (e.g., using antenna 252, demodulator 254, MIMO detector 256, receive processor 258, controller/processor 280, and/or memory 282) may receive, after transmitting the indication of the one or more switching options, information associated with an uplink transmission scheduled for the UE, wherein the uplink transmission is scheduled according to the one or more switching options supported by the UE, as described above.

Process 500 may include additional aspects, such as any single aspect or any combination of aspects described below and/or in connection with one or more other processes described elsewhere herein.

In a first aspect, process 500 includes performing uplink transmit switching in association with transmitting the uplink transmission scheduled for the UE, the uplink transmit switching being performed according to the one or more switching options supported by the UE.

In a second aspect, alone or in combination with the first aspect, the first band is a first TDD band and the second band is a second TDD band.

In a third aspect, alone or in combination with one or more of the first and second aspects, at least one of the first band or the second band is an FDD band.

In a fourth aspect, alone or in combination with one or more of the first through third aspects, the second band is an SUL band, and uplink MIMO is not permitted on the SUL band.

In a fifth aspect, alone or in combination with one or more of the first through fourth aspects, the one or more switching options include a switching option associated with switching among a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.

In a sixth aspect, alone or in combination with one or more of the first through fifth aspects, the one or more switching options include a switching option associated with switching among a first configuration that supports scheduling of concurrent uplink transmissions on a first antenna port and a second antenna port, scheduling of uplink transmissions on the second antenna port only, scheduling of uplink transmissions on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.

In a seventh aspect, alone or in combination with one or more of the first through sixth aspects, the second band is an SUL band, and uplink MIMO is permitted on the SUL band.

In an eighth aspect, alone or in combination with one or more of the first through seventh aspects, the one or more switching options include a switching option associated with switching among a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.

In a ninth aspect, alone or in combination with one or more of the first through eighth aspects, the one or more switching options include a switching option associated with switching among a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.

In a tenth aspect, alone or in combination with one or more of the first through ninth aspects, the UE is configured to expect that the uplink transmission is scheduled to provide the UE sufficient time to perform uplink transmit switching, in association with transmitting the uplink transmission, in accordance with a carrier aggregation slot offset value.

In an eleventh aspect, alone or in combination with one or more of the first through tenth aspects, process 500 includes identifying a switching scheduling error case based at least in part on a determination that the uplink transmission is not scheduled so as to provide the UE sufficient time to perform the uplink transmit switching.

In a twelfth aspect, alone or in combination with one or more of the first through eleventh aspects, process 500 includes skipping the performance of the uplink transmit switching in association with transmitting the uplink transmission based at least in part on a determination that the uplink transmission is not scheduled so as to provide the UE sufficient time to perform the uplink transmit switching.

In a thirteenth aspect, alone or in combination with one or more of the first through twelfth aspects, the UE is to configured for intra-band CA and is configured to check component carriers in a band used for intra-band CA in association with determining whether to perform uplink transmit switching.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, by a base station, in accordance with the present disclosure. Example process 600 is an example where the base station (e.g., base station 110) performs operations associated with uplink transmit switching for two frequency bands.

As shown in FIG. 6, in some aspects, process 600 may include receiving an indication of one or more switching options supported by a UE, wherein the one or more switching options are associated with performing uplink transmit switching for a first band and a second band (block 610). For example, the base station (e.g., using antenna 234, demodulator 232, MIMO detector 236, receive processor 238, controller/processor 240, and/or memory 242) may receive an indication of one or more switching options supported by a UE (e.g., a UE 120), wherein the one or more switching options are associated with performing uplink transmit switching for a first band and a second band, as described above. In some aspects, at least one of the first band or the second band is an FDD band, a TDD band, or an SUL band. In some aspects, uplink MIMO is permitted on the first band and the second band.

As further shown in FIG. 6, in some aspects, process 600 may include transmitting, after receiving the indication of the one or more switching options, information associated with an uplink transmission scheduled for the UE, wherein the uplink transmission is scheduled according to the one or more switching options supported by the UE (block 620). For example, the base station (e.g., using transmit processor 220, TX MIMO processor 230, modulator 232, antenna 234, controller/processor 240, memory 242, and/or scheduler 246) may transmit, after receiving the indication of the one or more switching options, information associated with an uplink transmission scheduled for the UE, wherein the uplink transmission is scheduled according to the one or more switching options supported by the UE, as described above.

Process 600 may include additional aspects, such as any single aspect or any combination of aspects described below and/or in connection with one or more other processes described elsewhere herein.

In a first aspect, the first band is a first TDD band, and the second band is a second TDD band.

In a second aspect, alone or in combination with the first aspect, at least one of the first band or the second band is a FDD band.

In a third aspect, alone or in combination with one or more of the first and second aspects, the second band is a SUL band, and uplink MIMO is not permitted on the SUL band.

In a fourth aspect, alone or in combination with one or more of the first through third aspects, the one or more switching options include a switching option associated with switching among a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.

In a fifth aspect, alone or in combination with one or more of the first through fourth aspects, the one or more switching options include a switching option associated with switching among a first configuration that supports scheduling of concurrent uplink transmissions on a first antenna port and a second antenna port, scheduling of uplink transmissions on the second antenna port only, scheduling of uplink transmissions on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.

In a sixth aspect, alone or in combination with one or more of the first through fifth aspects, the second band is a SUL band, and uplink MIMO is permitted on the SUL band.

In a seventh aspect, alone or in combination with one or more of the first through sixth aspects, the one or more switching options include a switching option associated with switching among a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.

In an eighth aspect, alone or in combination with one or more of the first through seventh aspects, the one or more switching options include a switching option associated with switching among a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

The following provides an overview of some Aspects of the present disclosure:
Aspect 1: A method of wireless communication performed by a user equipment (UE), comprising: transmitting an indication of one or more switching options supported by the UE, wherein the one or more switching options are associated with performing uplink transmit switching for a first band and a second band, wherein at least one of the first band or the second band is a frequency-division duplex (FDD) band, a time-division duplex (TDD) band, or a supplemental uplink (SUL) band; and receiving, after transmitting the indication of the one or more switching options, information associated with an uplink transmission scheduled for the UE, wherein the uplink transmission is scheduled according to the one or more switching options supported by the UE.
Aspect 2: The method of Aspect 1, further comprising performing uplink transmit switching in association with transmitting the uplink transmission scheduled for the UE, the uplink transmit switching being performed according to the one or more switching options supported by the UE.
Aspect 3: The method of any of Aspects 1-2, wherein the first band is a first TDD band and the second band is a second TDD band.
Aspect 4: The method of any of Aspects 1-2, wherein at least one of the first band or the second band is an FDD band.
Aspect 5: The method of any of Aspects 1-2, wherein the second band is an SUL band, and uplink multiple-input multiple-output (MIMO) is not permitted on the SUL band.
Aspect 6: The method of Aspect 5, wherein the one or more switching options include a switching option associated with switching among: a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.
Aspect 7: The method of Aspect 5, wherein the one or more switching options include a switching option associated with switching among: a first configuration that supports scheduling of concurrent uplink transmissions on a first antenna port and a second antenna port, scheduling of uplink transmissions on the second antenna port only, scheduling of uplink transmissions on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.
Aspect 8: The method of any of Aspects 1-2, wherein the second band is an SUL band, and uplink multiple-input multiple-output (MIMO) is permitted on the SUL band.
Aspect 9: The method of Aspect 8, wherein the one or more switching options include a switching option associated with switching among: a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.
Aspect 10: The method of Aspect 8, wherein the one or more switching options include a switching option associated with switching among: a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.
Aspect 11: The method of any of Aspects 1-10, wherein the UE is configured to expect that the uplink transmission is scheduled to provide the UE sufficient time to perform uplink transmit switching, in association with transmitting the uplink transmission, in accordance with a carrier aggregation slot offset value.
Aspect 12: The method of any of Aspects 1-11 further comprising identifying a switching scheduling error case based at least in part on a determination that the uplink transmission is not scheduled so as to provide the UE sufficient time to perform the uplink transmit switching.
Aspect 13: The method of any of Aspects 1-12, further comprising skipping the performance of the uplink transmit switching in association with transmitting the uplink transmission based at least in part on a determination that the uplink transmission is not scheduled so as to provide the UE sufficient time to perform the uplink transmit switching.
Aspect 14: The method of any of Aspects 1-13, wherein the UE is configured for intra-band carrier aggregation (CA) and is configured to check component carriers in a band used for intra-band CA in association with determining whether to perform uplink transmit switching.
Aspect 15: A method of wireless communication performed by a base station, comprising: receiving an indication of one or more switching options supported by a user equipment (UE), wherein the one or more switching options are associated with performing uplink transmit switching for a first band and a second band wherein at least one of the first band or the second band is a frequency-division duplex (FDD) band, a time-division duplex (TDD) band, or a supplemental uplink (SUL) band; and transmitting, after receiving the indication of the one or more switching options, information associated with an uplink transmission scheduled for the UE, wherein the uplink transmission is scheduled according to the one or more switching options supported by the UE.
Aspect 16: The method of Aspect 15, wherein the first band is a first TDD band and the second band is a second TDD band.
Aspect 17: The method of any of Aspects 15-16, wherein at least one of the first band or the second band is an FDD band.
Aspect 18: The method of any of Aspects 15-16, wherein the second band is an SUL band, and uplink multiple-input multiple-output (MIMO) is not permitted on the SUL band.
Aspect 19: The method of Aspect 18, wherein the one or more switching options include a switching option associated with switching among: a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.
Aspect 20: The method of Aspect 18, wherein the one or more switching options include a switching option associated with switching among: a first configuration that supports scheduling of concurrent uplink transmissions on a first antenna port and a second antenna port, scheduling of uplink transmissions on the second antenna port only, scheduling of uplink transmissions on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of uplink transmissions on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of uplink transmissions on the first antenna port only, and no uplink transmissions being scheduled on either the first antenna port or the second antenna port, wherein, in the third configuration, the first antenna port and the second antenna port are associated with the first band.
Aspect 21: The method of any of Aspects 15-16, wherein the second band is an SUL band, and uplink multiple-input multiple-output (MIMO) is permitted on the SUL band.
Aspect 22: The method of Aspect 21, wherein the one or more switching options include a switching option associated with switching among: a first configuration that supports scheduling of uplink transmissions on a second antenna port only, scheduling of uplink transmissions on a first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.
Aspect 23: The method of Aspect 21, wherein the one or more switching options include a switching option associated with switching among: a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port, wherein, in the first configuration, the first antenna port is associated with the first band and the second antenna port is associated with the second band, a second configuration that supports scheduling of concurrent uplink transmissions on the first antenna port and the second antenna port, scheduling of an uplink transmission on the second antenna port only, and no uplink transmissions being scheduled on either the first antenna port or the second antenna port, wherein, in the second configuration, the first antenna port and the second antenna port are associated with the second band, and a third configuration that supports scheduling of concurrent uplink transmissions on the first antenna port and the second antenna port, scheduling of an uplink transmission on the first antenna port only, and no uplink transmissions being scheduled on either the first antenna port or the second antenna port, wherein, in the third configuration, the first antenna port and the second antenna port are associated with the first band.
Aspect 24: An apparatus for wireless communication at a device, comprising a processor; memory coupled with the processor; and instructions stored in the memory and executable by the processor to cause the apparatus to perform the method of one or more of Aspects 1-14.
Aspect 25: A device for wireless communication, comprising a memory and one or more processors coupled to the memory, the one or more processors configured to perform the method of one or more of Aspects 1-14.
Aspect 26: An apparatus for wireless communication, comprising at least one means for performing the method of one or more of Aspects 1-14.
Aspect 27: A non-transitory computer-readable medium storing code for wireless communication, the code comprising instructions executable by a processor to perform the method of one or more of Aspects 1-14.
Aspect 28: A non-transitory computer-readable medium storing a set of instructions for wireless communication, the set of instructions comprising one or more instructions that, when executed by one or more processors of a device, cause the device to perform the method of one or more of Aspects 1-14.
Aspect 29: An apparatus for wireless communication at a device, comprising a processor; memory coupled with the processor; and instructions stored in the memory and executable by the processor to cause the apparatus to perform the method of one or more of Aspects 15-23.
Aspect 30: A device for wireless communication, comprising a memory and one or more processors coupled to the memory, the one or more processors configured to perform the method of one or more of Aspects 15-23.
Aspect 31: An apparatus for wireless communication, comprising at least one means for performing the method of one or more of Aspects 15-23.
Aspect 32: A non-transitory computer-readable medium storing code for wireless communication, the code comprising instructions executable by a processor to perform the method of one or more of Aspects 15-23.
Aspect 33: A non-transitory computer-readable medium storing a set of instructions for wireless communication, the set of instructions comprising one or more instructions that, when executed by one or more processors of a device, cause the device to perform the method of one or more of Aspects 15-23.

The foregoing disclosure provides illustration and description, but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method of wireless communication performed by a user equipment (UE), comprising:
transmitting an indication of one or more switching options supported by the UE, wherein the one or more switching options are associated with performing uplink transmit switching for a first band and a second band,
wherein at least one of the first band or the second band is a frequency-division duplex (FDD) band, a time-division duplex (TDD) band, or a supplemental uplink (SUL) band, and
wherein uplink multiple-input multiple-output (MIMO) is permitted on the first band and the second band; and
receiving, after transmitting the indication of the one or more switching options, information associated with an uplink transmission scheduled for the UE, wherein the uplink transmission is scheduled according to the one or more switching options supported by the UE.

2. The method of claim 1, further comprising performing uplink transmit switching in association with transmitting the uplink transmission scheduled for the UE, the uplink transmit switching being performed according to the one or more switching options supported by the UE.

3. The method of claim 1, wherein the first band is a first TDD band and the second band is a second TDD band.

4. The method of claim 1, wherein at least one of the first band or the second band is an FDD band.

5. The method of claim 1, wherein the second band is an SUL band, and uplink MIMO is permitted on the SUL band.

6. The method of claim 5, wherein the one or more switching options include a switching option associated with switching among:
a first configuration that supports scheduling of uplink transmissions on a second antenna port only, scheduling of uplink transmissions on a first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

7. The method of claim 5, wherein the one or more switching options include a switching option associated with switching among:
a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

8. The method of claim 1, wherein the UE is configured to expect that the uplink transmission is scheduled to provide the UE sufficient time to perform uplink transmit switching, in association with transmitting the uplink transmission, in accordance with a carrier aggregation slot offset value.

9. The method of claim 1, further comprising identifying a switching scheduling error case based at least in part on a determination that the uplink transmission is not scheduled so as to provide the UE sufficient time to perform the uplink transmit switching.

10. The method of claim 1, further comprising skipping the performance of the uplink transmit switching in association with transmitting the uplink transmission based at least in part on a determination that the uplink transmission is not scheduled so as to provide the UE sufficient time to perform the uplink transmit switching.

11. The method of claim 1, wherein the UE is configured for intra-band carrier aggregation (CA) and is configured to check component carriers in a band used for intra-band CA in association with determining whether to perform uplink transmit switching.

12. A method of wireless communication performed by a base station, comprising:
receiving an indication of one or more switching options supported by a user equipment (UE), wherein the one or more switching options are associated with performing uplink transmit switching for a first band and a second band
wherein at least one of the first band or the second band is a frequency-division duplex (FDD) band, a time-division duplex (TDD) band, or a supplemental uplink (SUL) band, and
wherein uplink multiple-input multiple-output (MIMO) is permitted on the first band and the second band; and
transmitting, after receiving the indication of the one or more switching options, information associated with an uplink transmission scheduled for the UE, wherein the uplink transmission is scheduled according to the one or more switching options supported by the UE.

13. The method of claim 12, wherein the first band is a first TDD band and the second band is a second TDD band.

14. The method of claim 12, wherein at least one of the first band or the second band is an FDD band.

15. The method of claim 12, wherein the second band is an SUL band, and uplink MIMO is permitted on the SUL band.

16. The method of claim 15, wherein the one or more switching options include a switching option associated with switching among:
a first configuration that supports scheduling of uplink transmissions on a second antenna port only, scheduling of uplink transmissions on a first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

17. The method of claim 15, wherein the one or more switching options include a switching option associated with switching among:
a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

18. An apparatus for wireless communication, comprising:
means for transmitting an indication of one or more switching options supported by the apparatus, wherein the one or more switching options are associated with performing uplink transmit switching for a first band and a second band,
wherein at least one of the first band or the second band is a frequency-division duplex (FDD) band, a time-division duplex (TDD) band, or a supplemental uplink (SUL) band, and
wherein uplink multiple-input multiple-output (MIMO) is permitted on the first band and the second band; and
means for receiving, after transmitting the indication of the one or more switching options, information associated with an uplink transmission scheduled for the apparatus, wherein the uplink transmission is scheduled according to the one or more switching options supported by the apparatus.

19. The apparatus of claim 18, further comprising means for performing uplink transmit switching in association with transmitting the uplink transmission scheduled for the UE, the uplink transmit switching being performed according to the one or more switching options supported by the UE.

20. The apparatus of claim 18, wherein the first band is a first TDD band and the second band is a second TDD band.

21. The apparatus of claim 18, wherein at least one of the first band or the second band is an FDD band.

22. The apparatus of claim 18, wherein the second band is an SUL band, and uplink MIMO is permitted on the SUL band.

23. The apparatus of claim 22, wherein the one or more switching options include a switching option associated with switching among:
a first configuration that supports scheduling of uplink transmissions on a second antenna port only, scheduling of uplink transmissions on a first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

24. The apparatus of claim 22, wherein the one or more switching options include a switching option associated with switching among:
a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

25. An apparatus for wireless communication, comprising:
means for receiving an indication of one or more switching options supported by a user equipment (UE), wherein the one or more switching options are associated with performing uplink transmit switching for a first band and a second band,
wherein at least one of the first band or the second band is a frequency-division duplex (FDD) band, a time-division duplex (TDD) band, or a supplemental uplink (SUL) band, and
wherein uplink multiple-input multiple-output (MIMO) is permitted on the first band and the second band; and
means for transmitting, after receiving the indication of the one or more switching options, information associated with an uplink transmission scheduled for the UE, wherein the uplink transmission is scheduled according to the one or more switching options supported by the UE.

26. The apparatus of claim 25, wherein the first band is a first TDD band and the second band is a second TDD band.

27. The apparatus of claim 25, wherein at least one of the first band or the second band is an FDD band.

28. The apparatus of claim 25, wherein the second band is an SUL band, and uplink MIMO is permitted on the SUL band.

29. The apparatus of claim 28, wherein the one or more switching options include a switching option associated with switching among:
a first configuration that supports scheduling of uplink transmissions on a second antenna port only, scheduling of uplink transmissions on a first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.

30. The apparatus of claim 28, wherein the one or more switching options include a switching option associated with switching among:
a first configuration that supports scheduling of concurrent uplink transmissions on a first antenna port and a second antenna port, scheduling of an uplink transmission on the second antenna port only, scheduling of an uplink transmission on the first antenna port only, and no uplink transmissions being scheduled on either the first antenna port or the second antenna port,
wherein, in the first configuration, the first antenna port is associated with the first band and the second antenna port is associated with the second band,
a second configuration that supports scheduling of concurrent uplink transmissions on the first antenna port and the second antenna port, scheduling of an uplink transmission on the second antenna port only, and no uplink transmissions being scheduled on either the first antenna port or the second antenna port,
wherein, in the second configuration, the first antenna port and the second antenna port are associated with the second band, and
a third configuration that supports scheduling of concurrent uplink transmissions on the first antenna port and the second antenna port, scheduling of an uplink transmission on the first antenna port only, and no uplink transmissions being scheduled on either the first antenna port or the second antenna port,
wherein, in the third configuration, the first antenna port and the second antenna port are associated with the first band.
